(19) United States
(12) Patent Application Publication
(10) Pub. No.: US 2024/0135316 A1
(43) Pub. Date: Apr. 25, 2024

(54) SUPPLY CHAIN MANAGEMENT USING CMMIS

(71) Applicant: SAUDI ARABIAN OIL COMPANY, Dhahran (SA)

(72) Inventors: Abdullah S. Al-husaiki Al-ghamdi, Dhahran (SA); Saad M. Qahtani, Dhahran (SA); Mubarak H. Hajri, Dhahran (SA); Rami Z. Amri, Dhahran (SA); Majed A. Jameel, Dhahran (SA); Saad A. Qahtani, Dhahran (SA)

(73) Assignee: SAUDI ARABIAN OIL COMPANY, Dhahran (SA)

(21) Appl. No.: 18/048,195

(22) Filed: Oct. 19, 2022

(51) Int. Cl. G06Q 10/087

(52) U.S. Cl. CPC G06Q 10/087

(57) ABSTRACT

A method for providing automated supply chain management at one or more locations involves monitoring the one or more locations in order to calculate one or more supply chain metrics, and determining whether at least one of the supply chain metrics has exceeded an alarm level. The method also includes, in response to determining that at least one of the supply chain metrics has exceeded the alarm level, automatically performing a remedial action at a location that was responsible for the alarm. The one or more supply chain metrics are related to one or more of: emergency purchases, canceled purchases, and aged inventory. Each of the one or more supply chain metrics is assigned an individual weighted supply chain metric score out of 100.

### BACKGROUND

An organization's supply chain generally refers to the raw goods that it consumes in the process of generating finished products and services and turning a profit. Proper Supply Chain Management (SCM) is critical to the functioning of any organization. Regardless of what finished products or services an organization provides, current and accurate representation of its supply chain behavior is central to fully understanding expenditures and maximizing the value of its inputs versus outputs. Failure to properly manage a company's supply chain can result in many inefficient behaviors, such as: overstocking raw supplies, writing off or auctioning supplies from one division that could be used by another division, failing to coordinate similar orders that could have been combined for the purposes of capturing bulk pricing, and paying a surcharge to order supplies at the last minute. Frequently these inefficient behaviors are the result of antiquated SCM procedures that rely on lengthy manual reporting mechanisms. These SCM procedures often require human intervention to read and analyze data and to provide future guidance. It is therefore an object of the present invention to provide an automated SCM solution that does not rely on human intervention to generate immediate feedback and up-to-date supply chain information. It is another object of the present invention to provide an SCM solution that improves efficiency and reduces costs throughout a company's supply chain. These and other topics will be discussed below.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method, a computer-readable medium, and a system for providing automated supply chain management at one or more locations.

In one embodiment, a method is provided for providing automated supply chain management at one or more locations. The method may comprise monitoring the one or more locations in order to calculate one or more supply chain metrics. The method may further include determining whether at least one of the supply chain metrics has exceeded an alarm level. Next, the method may include, in response to determining that at least one of the supply chain metrics has exceeded the alarm level, automatically performing a remedial action at a location that was responsible for the alarm. In one or more embodiments of the method, the one or more supply chain metrics are related to one or more of: emergency purchases, canceled purchases, and aged inventory. In one or more embodiments of the method, each of the one or more supply chain metrics is assigned an individual weighted supply chain metric score out of 100.

In one or more embodiments of the method, monitoring the one or more locations, calculating the one or more metrics, and automatically performing the remedial action are performed by a computer without any human intervention.

In one or more embodiments of the method, aged inventory further comprises an aged inventory metric, and calculating the aged inventory metric comprises applying a linear regression machine learning model that uses historical inventory consumption data.

In one or more embodiments of the method, performing the remedial action comprises offering the aged inventory to another of the one or more locations that was not responsible for the alarm, and wherein the another of the one or more locations automatically purchases and takes possession of the aged inventory based on having a matching open order for the aged inventory.

In one or more embodiments of the method, the method further comprises, in response to performing the remedial action, automatically recalculating the one or more supply chain metrics associated with the location that was responsible for the alarm.

In one or more embodiments of the method, the one or more supply chain metrics comprise two or more supply chain metrics as well as an aggregate metric.

In one or more embodiments of the method, the aggregate metric is calculated by summing the individual weighted supply chain metrics scores for each of the two or more supply chain metrics.

In one embodiment, a non-transitory computer-readable storage medium is provided. The non-transitory computer-readable storage medium may have computer-readable instructions stored thereon, which when executed by a computer cause the computer to perform one or more operations for providing automated supply chain management. The operations may comprise monitoring one or more locations in order to calculate one or more supply chain metrics. The operations may further include determining whether at least one of the supply chain metrics has exceeded an alarm level. Next, the operations may include, in response to determining that at least one of the supply chain metrics has exceeded the alarm level, automatically performing a remedial action at a location that was responsible for the alarm. In one or more embodiments of the computer-readable medium, the one or more supply chain metrics are related to one or more of: emergency purchases, canceled purchases, and aged inventory. In one or more embodiments of the computer-readable medium, each of the one or more supply chain metrics is assigned an individual weighted supply chain metric score out of 100.

In one or more embodiments of the computer-readable medium, monitoring the one or more locations, calculating the one or more metrics, and automatically performing the remedial action are performed by a computer without any human intervention.

In one or more embodiments of the computer-readable medium, aged inventory further comprises an aged inventory metric, and calculating the aged inventory metric comprises applying a linear regression machine learning model that uses historical inventory consumption data.

In one or more embodiments of the computer-readable medium, performing the remedial action comprises offering the aged inventory to another of the one or more locations that was not responsible for the alarm, and wherein the another of the one or more locations automatically purchases and takes possession of the aged inventory based on having a matching open order for the aged inventory.

In one or more embodiments of the computer-readable medium, the operations further comprise, in response to performing the remedial action, automatically recalculating the one or more supply chain metrics associated with the location that was responsible for the alarm.

In one or more embodiments of the computer-readable medium, the one or more supply chain metrics comprise two or more supply chain metrics as well as an aggregate metric.

In one or more embodiments of the computer-readable medium, the aggregate metric is calculated by summing the individual weighted supply chain metrics scores for each of the two or more supply chain metrics.

In one embodiment, a system is provided for providing automated supply chain management. The system may comprise one or more manufacturing locations. The system may further comprise an automated supply chain management computer. The supply chain management computer may be configured to monitor the one or more locations in order to calculate one or more supply chain metrics. The supply chain management computer may be configured to determine whether at least one of the supply chain metrics has exceeded an alarm level. Next, the supply chain management computer may be configured to, in response to determining that at least one of the supply chain metrics has exceeded the alarm level, automatically perform a remedial action at a location that was responsible for the alarm. In one or more embodiments of the system, the one or more supply chain metrics are related to one or more of: emergency purchases, canceled purchases, and aged inventory. In one or more embodiments of the system, each of the one or more supply chain metrics is assigned an individual weighted supply chain metric score out of 100.

In one or more embodiments of the system, monitoring the one or more locations, calculating the one or more metrics, and automatically performing the remedial action are performed by a computer without any human intervention.

In one or more embodiments of the system, aged inventory further comprises an aged inventory metric, and calculating the aged inventory metric comprises applying a linear regression machine learning model that uses historical inventory consumption data.

In one or more embodiments of the system, performing the remedial action comprises offering the aged inventory to another of the one or more locations that was not responsible for the alarm, and wherein the another of the one or more locations automatically purchases and takes possession of the aged inventory based on having a matching open order for the aged inventory.

In one or more embodiments of the system, the supply chain management computer is further configured to, in response to performing the remedial action, automatically recalculate the one or more supply chain metrics associated with the location that was responsible for the alarm.

In one or more embodiments of the system, the one or more supply chain metrics comprise two or more supply chain metrics as well as an aggregate metric.

In one or more embodiments of the system, the aggregate metric is calculated by summing the individual weighted supply chain metrics scores for each of the two or more supply chain metrics.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

FIG. 1 shows an enterprise having one plant in accordance with one or more embodiments.

FIG. 2 shows an enterprise having two plants in accordance with one or more embodiments.

FIG. 3 shows an enterprise having four plants that are interconnected in accordance with one or more embodiments.

FIG. 4 shows a system for connecting four plants in accordance with one or more embodiments.

FIG. 5 shows a computing node in accordance with one or more embodiments.

FIG. 6 shows automated supply chain statistics in accordance with one or more embodiments.

FIG. 7 shows methods for calculating supple chain statistics in accordance with one or more embodiments.

FIG. 8 depicts an automated supply chain management process in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although various embodiments may be described with respect to a system, a non-transitory computer-readable medium, and a method, it is contemplated that embodiments with identical or substantially similar features may alternatively be implemented as methods, systems, and/or non-transitory computer-readable media.

In this disclosure, the terms company, business, organization, and enterprise may be used interchangeably.

Embodiments disclosed herein relate to a Corporate Materials Management Index (CMMI) to measure the performance of organizational or enterprise departments in a plurality of materials management categories and display each departments' monthly scores in order to optimize inventory and improve customer behaviors during material ordering processes.

In one or more embodiments, the data of the plurality of materials management categories (e.g., Aged Inventory, Technical Evaluation processing time, 9CAT & 9COM consumption, Emergency Purchase Requisitions, Deleted reservations, and Overdue Staged Material, which are examples of key components of the CMMI composite) are extracted from Procurement Supply Chain Management (PSCM) Customers database and are designed in way to show the performance of each department. The value of each category is calculated and the results are shown in ranges to distinguish between highest and lowest performers. A total score (out of 100) is calculated by summing up the weighted performance score of the plurality of components. The components of CMMI and the weight distribution are based on the importance of the KPIs.

Operation Departments (customers) tend to request their materials without realizing the impact of unused aged inventory, or stocking more of overdue stage materials, or processing more emergency orders. The methodology disclosed herein helps customers to better understand how to make proper materials planning to avoid building unnecessary inventory. In one or more embodiments, this method uses predictive analytics to gauge customers behavior in the above plurality of materials management categories and address their real requirements and avoid unnecessary inventory investment.

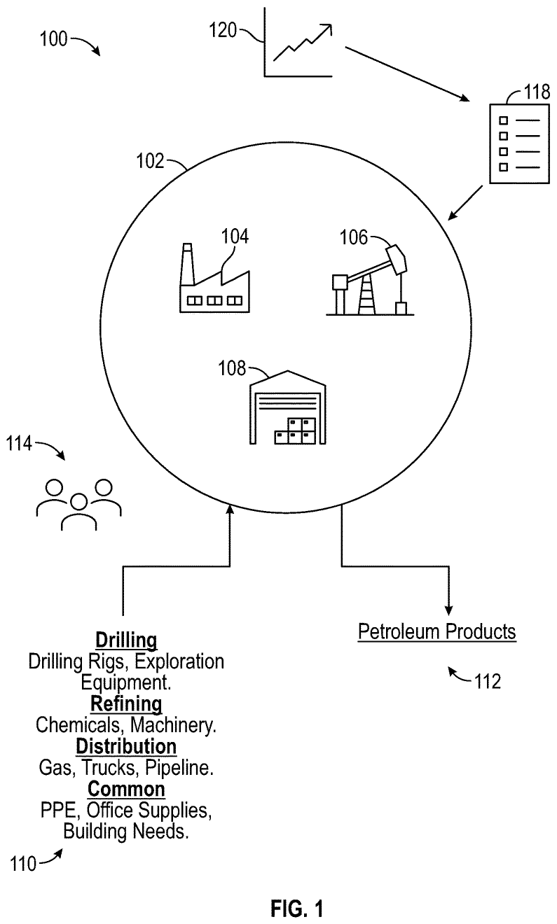

FIG. 1 shows an enterprise 100 with first plant 102 in accordance with some embodiments. First plant 102 of enterprise 100 may be a single plant involved in the production of a single product line. For example, first plant 102 may be involved in the production of petroleum products, but this example is not intended to be limiting. Alternatively, first plant 102 may be involved in the production of metal ore, and this would not depart from the spirit and scope of the invention. In order to carry out its business of petroleum production, first plant 102 may comprise one or more separate entities 104-108. For example, first plant 102 may have one or more refineries 104, one or more drilling sites 106, and one or more warehouses 108. The execution of routine business operations at first plant 102 may generally be referred to as Maintenance, Repair, and Operations (MRO). During the course of MRO, first plant 102 may consume one or more raw inputs 110 in order to generate one or more finished outputs 112. Finished outputs 112 may comprise one or more petroleum products, and raw inputs 110 may comprise one or more categories of inputs. Raw inputs 110 may have input categories related to drilling, refining, and distribution, as well as a common category of inputs that are related to all operations of first plant 102. The drilling category of inputs may include drilling rigs and exploration equipment. The refining category of inputs may include chemicals and machinery. The distribution category of inputs may include gasoline, trucks, and pipeline. The common category of inputs may include personal protective equipment (PPE), office supplies, and building needs. In this example, raw inputs 110 may represent the supply chain of enterprise 100.

Enterprise 100 may employ plant management 114 in order to maximize profits at first plant 102. Plant management 114 may include one or more plant managers. In pursuit of its goal, plant management 114 may attempt to minimize the cost of raw inputs 110 that are purchased, while simultaneously ensuring the continued production of finished outputs 112 that are sold on an open market 120. The open market 120 may drive production at first plant 102 by sending one or more purchase orders 118 requesting finished outputs 112. As purchase orders 118 are received, first plant 102 may fill the orders by both: using existing finished outputs 112 in warehouse 108, and modulating the production of new finished outputs 112. In carrying out its job, plant management 114 may monitor purchase orders 118 and production at first plant 102 in order to predict the need for raw inputs 110 and order them for the lowest price possible on the open market 120. Since the cost and supply of raw inputs 110 is dictated by open market 120, plant management 114 may have a tough time acquiring raw inputs 110 in the most efficient way possible. For example, if plant management 114 overestimates production at first plant 102, it may be tempted to purchase raw inputs 110 at a lower price and a higher bulk, which results in unused raw inputs 110. Depending on the severity of its overestimation, plant management 114 may have to sell unused raw inputs 110 at a loss in order to make room in warehouse 108, or it may have to dispose of unused raw inputs 110 that have reached their shelf life and subsequently spoil. Alternatively, if plant management 114 underestimates production at first plant 102, it may be tempted to purchase raw inputs 110 at a lower bulk and higher price, which may result in chronically low stocks of raw inputs 110. Continued underestimation and chronically low stocks of raw inputs 110 may cause first plant 102 to repeatedly spend excess money on orders of lower bulk and higher price, or even pay a surcharge for rush orders of raw inputs 110 if there is any risk of production stopping or the terms of purchase orders 118 not being satisfied. Further, if first plant 102 still relies on manual human SCM analysis, inefficient supply chain behaviors may exist at enterprise 100 for longer than necessary, or indefinitely. It will be appreciated that enterprise 100 may benefit from an improved mechanism for managing its supply chain of raw inputs 110 at first plant 102.

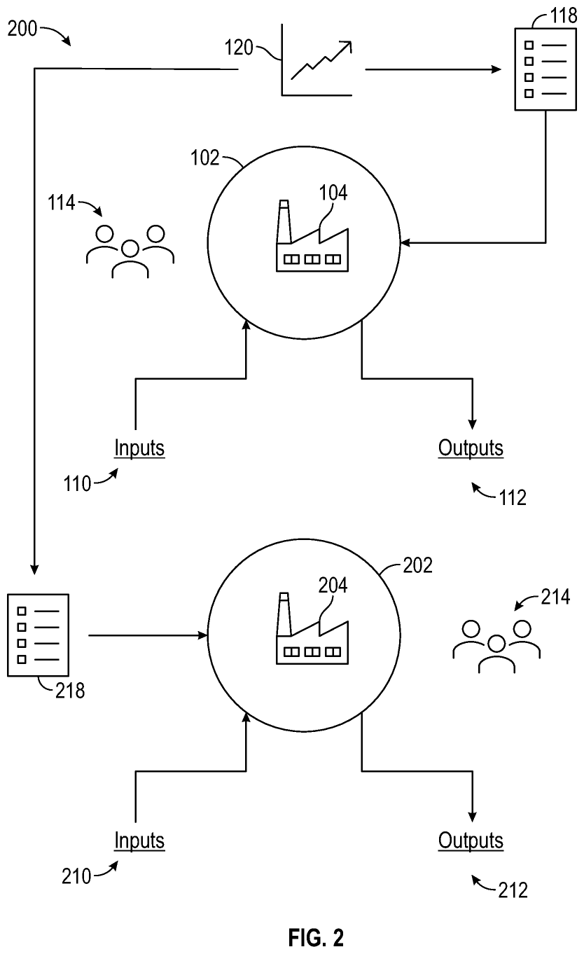

FIG. 2 shows an enterprise 200 with second plant 202 in addition to first plant 102 in accordance with some embodiments. Second plant 202 and its associated elements of enterprise 200, as well as first plant 102 and its associated elements of enterprise 200 may be similar or identical to those of first plant 102 of enterprise 100. Further, although first plant 102 and second plant 202 of enterprise 200 are depicted without one or more drilling sites 106 and warehouses 108, this is only done as a matter of convenience, and it will be appreciated that these elements 106-108 may still be present at first plant 102 and second plant 202 of enterprise 200. For example, second plant 202 may have one or more refineries 204. Similar to enterprise 100, enterprise 200 may employ plant management 114 in order to maximize profits at first plant 102, as well as plant management 214 in order to maximize profits at second plant 202. The second plant 202 also deal with purchase orders 218, has raw inputs (210) and outputs (212) as described above with respect to the first plant. While enterprise 200 may have twice the output capacity of enterprise 100, if it still relies on manual human SCM analysis, then inefficient supply chain behaviors may also still exist at enterprise 200 indefinitely or for longer than necessary, as with enterprise 100.

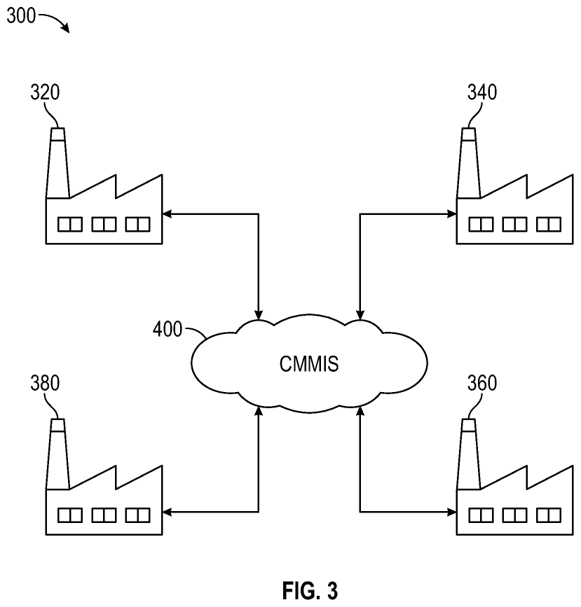

FIG. 3 shows an enterprise 300 with plants 320, 340, 360, and 380 in accordance with some embodiments. Although enterprise 300 is depicted with four plants 320-380, it will be appreciated that enterprise 300 may compromise more or less than four plants without departing from the spirit and scope of the invention. Similar to plants 102 and 202 of FIG. 2, plants 320-380 may each have one or more drilling sites 106 and warehouses 108, even though they are not depicted. Plants 320-380 of enterprise 300 may perform similar functions as plants 102 and 202 of enterprise 200, with the exception that plants 320-380 of enterprise 300 are also connected via a Corporate Material Management Information System (CMMIS) 400. CMMIS 400 may facilitate the automated transmission of supply chain information and feedback amongst plants 320-380, and also between plants 320-380 and a corporate headquarters of enterprise 300. In order to provide automated supply chain information and feedback, CMMIS 400 may contain a plurality of computers and decision making logic, as will be discussed in further detail below.

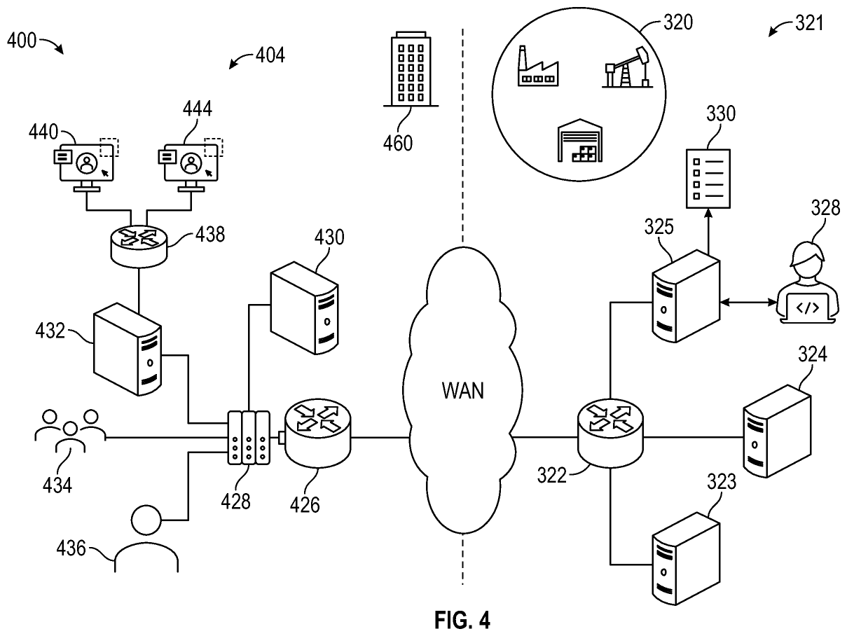

FIG. 4 shows additional features within CMMIS 400 of enterprise 300 in accordance with some embodiments. CMMIS 400 may include plant network 321 with devices 322-325 physically located at plant 320, and corporate network 404 with devices 426-444 physically located at corporate office 460. Plant 320 may include a refinery, a warehouse, and a drilling site, although this is not intended to be limiting. In some embodiments, plant network 321 and corporate network 404 are interconnected via Wide Area Network (WAN) 410, which may include the Internet. Although CMMIS 400 only shows one plant 320, plant network 321, and associated devices 322-325 connected to corporate network 404, this is only done as a matter of convenience. It will be appreciated that CMMIS 400 may preferably connect a plurality of plants and plant networks with corporate network 404, as is shown in FIG. 3 where CMMIS 400 interconnects all four plants 320-380. For example, continuing with the numbering scheme use for plant 320, plant 340 may also connect to corporate network 404 via its own plant network 341 and associated devices 342-345, and elements 341-345 of plant 340 may be similar to analogous elements 321-325 of plant 320. Plant 360 may also connect to corporate network 404 via its own plant network 361 and associated devices 362-365, and elements 361-365 of plant 360 may be similar to analogous elements 321-325 of plant 320. Plant 380 may also connect to corporate network 404 via its own plant network 381 and associated devices 382-385, and elements of plant 380 may be similar to analogous elements 321-325 of plant 320. In this way, CMMIS 400 may interconnect all four plants 320-380, and every plant 320-380 may have an analogous copy of every element present at plant 320 of FIG. 4.

Returning to plant 320, plant network 321 may include a number of devices 322-325 that support the normal functioning of plant 320. Plant router 322 may route traffic between WAN 410 and devices 323-325. In carrying out its routing functions, plant router 322 may implement a number of routing protocols. For example, plant router 322 may implement one or more of: border gateway protocol (BGP), open shortest path first (OSPF), multi-protocol label switching (MPLS), and asynchronous transfer mode (ATM). This list is not meant to be limiting, and plant router 322 may implement various other routing protocols. On plant network 321 may be a number of servers 323-325, which may be Linux servers, Unix servers, active directory (AD) servers, or macOS™ servers. Servers 323-325 may include: HTTP server 323, email server 324, and one or more industrial servers 325. HTTP server 323 may include websites and URLs that provide access to web browsing services. Email server 324 may provide POPS or IMAP email messaging services to users on plant network 321. It will be appreciated that servers 323-325, in tandem with plant network 321, may record all historical information and functions related to plant 320, which may comprise bulk raw data, and send the information to corporate network 404 for analysis and processing. Servers 323-325 may automatically send information to corporate network 404, or servers 323-325 may simply record information and send it to corporate network 404 upon request.

Industrial server 325 may provide an interface for one or more plant managers 328 to perform supply chain functions at plant 320. Plant managers 328 may perform similar supply functions for plant 320 as plant management 114 performs for first plant 102 and plant management 214 perform for second plant 202 in FIGS. 1-2 above. For example, plant managers 328 may monitor production at plant 320 in order to purchase and manage input supplies at the lowest possible cost. Additionally, plant managers 328 may modulate their supply chain behaviors based on the reception of supply chain statistics and remedial actions, as will be discussed in further detail above.

Industrial server 325 may also be provided for recording industrial processing information associated with plant 320. Industrial processing information may include supply chain information 330 associated with plant 320, as well as other information associated with plant 320. Supply chain information 330 associated with plant 320 may include supply chain purchase transaction data as well as supply chain warehouse data, which may be generated by plant managers 328. Supply chain purchase transaction data may comprise a history of all supply chain purchase transactions at plant 320, including type, cost, and quantity of items purchased. Supply chain warehouse data may comprise a history of all items transported through the warehouse at plant 320, including if and when warehouse items were consumed, how long they were stored, and whether they were auctioned or written-off. It will be appreciated that industrial processing information and supply chain information 330 recorded by industrial server 325 may include both raw and processed data associated with plant 320. Further, plant network 321 may provide any combination of this data to corporate network 404 automatically or upon request. In one or more embodiments, CMMIS 400 may generate and analyze supply chain information 330 in order to more efficiently guide behavior at plant 320, and in order to provide automated feedback for plant 320. These and other aspects of supply chain information 330 will be discussed in further detail below.

Corporate network 404 may represent the entire contents of a company's backend corporate information technology (IT) infrastructure. As mentioned above, corporate network 404 may be housed at corporate office 460, or it may be housed at a datacenter. The particular devices depicted in corporate network 404 are meant to be exemplary only and are not intended to be limiting. For example, in practice, corporate network 404 may include more or less devices than are depicted in FIG. 4. In several embodiments, corporate network 404 may duplicate and provide similar functions as plant network 321, as well as provide additional advanced processing functions, as will be discussed in further detail below.

Corporate network 404 may contain a variety of devices 426-444. Corporate router 426 may route traffic between WAN 410 and devices 426-444. Corporate network 404 may also contain a network switch 428 that connects all devices of corporate network 404. In some embodiments, corporate router 426 and network switch 428 may be combined into a single device that carries out both functions. On corporate network 404 may be a number of server 430-432, which may be Linux servers, Unix servers, active directory (AD) servers, or macOS™ servers. Servers 430-432 may include: network server 430 and SCM server 432. In general, SCM server 432 may provide access to advanced SCM analytics and processing functions, and network server 430 may support the normal functioning of corporate network 404. Network server 430 may provide HTTP and email services, similar to servers 420-422 of plant network 321. Another function of network server 430 may be controlling and authenticating users 434. In one or more embodiments, users 434 may represent all users accessing corporate network 404, such as employees, managers, contractors, IT staff, and visitors that are granted temporary access. Network server 430 may also initialize and authenticate any users accessing plant network 321. Corporate network 404 may be provided with one or more network administrators 436, which may be in charge of configuring and reconfiguring every devices of corporate network 404. Users 434 and network administrators 436 may access corporate network 404 via one or more client computing devices, which are not depicted only as a matter of convenience.

In order to provide access to advanced SCM analytics and processing functions, SCM server 432 may be connected to nodes 440 and 444. A dedicated SCM router 438 with an integrated firewall may be provided between SCM server 432 and nodes 440-444, which may provide an extra layer of protection against hackers attempting to access nodes 440-444. Some embodiments may include only node 440, some embodiments may include only node 444, and some embodiments may include both nodes 440-444. To provide access to advanced SCM analytics and processing functions, node 440 may be an Automated Supply Chain Management (ASCM) node 440. Additionally, to provide access to more complex and comprehensive SCM analytics and processing functions, node 444 may be an Advanced Horizontal Supply Chain Management with Demand Forecasting (AHSCMDF) node 444. Each of nodes 440-444 may be comprised of: a single server, multiple rack-mounted blade servers, an allocation of virtual servers at a datacenter, or a neural network of servers comprising one or more datacenters. It will be appreciated that the size and configuration of nodes 440-444 may be modulated based on the size and complexity of problems being solved by enterprise 300. The processing and interconnection of devices on CMMIS 400 may allow CMMIS 400 to provide automated supply chain information and feedback for enterprise 300, as will be discussed in further detail below.

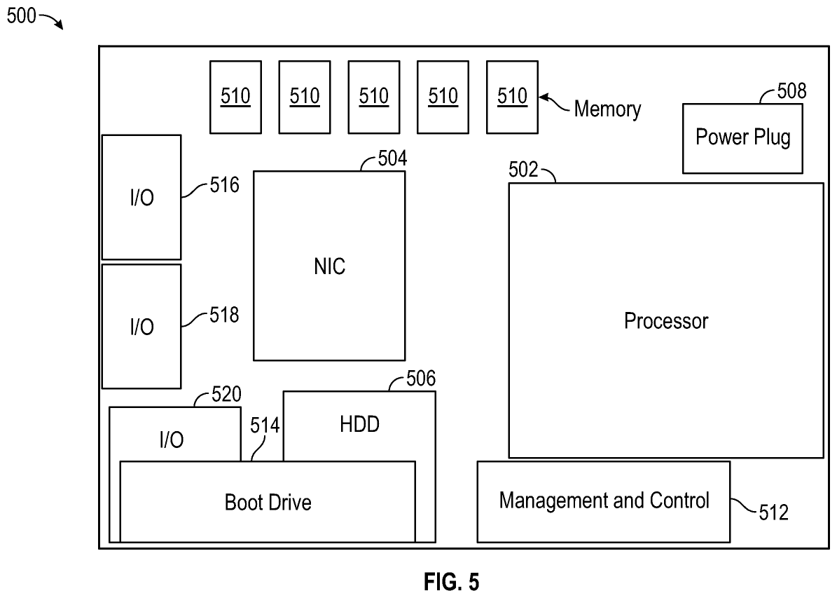

FIG. 5 shows a computing node 500 in accordance with one or more embodiments. The computing node 500 may comprise essential elements of operation for one or more devices on CMMIS 400 of FIG. 3 and FIG. 4, including but not limited to nodes 440-444. This disclosure is not meant to be limiting. For example, devices on CMMIS 400 may include more or less elements than are depicted on computing node 500. The example computing node 500 includes processor 502, memory devices 510, power plug 508, network interface controller (NIC) 504, hard disk drive (HDD) 506, management and control circuit 512, boot drive 514, and input output (I/O) circuitry 516-520. Processor 502 comprises a processor and interface for communicating with various sensors and transducers via NIC 504 over I/O circuitry 516, 518 and 520. Processor 502 also comprises a communication interface with memory 510. In some embodiments processor 502 may be an SoC (System-on-a-Chip), a general purpose processor, an application specific integrated circuit (ASIC), or another device that provides processing capability and communicates with I/O circuitry 516-520. In some embodiments, management and control circuit 512 manages conditions of computing node 500 such as temperature conditions. In some embodiments, management and control circuit 512 includes an interface for connecting with an external health monitoring system, such as an intelligent platform management interface (IPMI). In some embodiments, memory devices 510 are RAM devices such as double data rate fourth generation synchronous dynamic random-access memory (DDR4) or other suitable RAM devices.

Power connector 508 may be configured to receive electrical power via a cable connection, and in some embodiments, power connector 508 may be configured to couple with a backplane and receive electrical power via the backplane. In some embodiments, boot drive 514 is a solid state drive that stores program instructions for booting computing node 500. In some embodiments, boot instructions for computing node 500 may be stored in a remote location and boot drive 514 may be omitted.

Processor 502 communicates over I/O circuitry 516-520 with the aid of NIC 504. In some embodiments, I/O circuitry 516-520 may provide wired connections, such as small form factor pluggable IEEE 802.3 Ethernet ports or other suitable ports for a wired connection. I/O circuitry 516-520 may also support wireless connections, such as IEEE 802.11 WLAN connections, 3GPP 4G and 5G cellular connections, or a combination of both. I/O circuitry 516-520 may all provide wired connections, all provide wireless connections, or provide both wireless and wired connections.

HDD 506 may permanently store data and programs necessary for the functioning of computing node 500. HDD 506 may include traditional storage technology such as rotating magnetic platters that are accessed by one or more electromagnetic heads, or HDD 506 may include newer solid state disks (SSDs) that store information in flash memory, such as NAND flash and/or NOR flash. HDD 506 may employ any number of long-term storage transfer protocols, such as Parallel ATA (PATA), Serial ATA (SATA), and/or Small Computer System Interface (SCSI). HDD 506 may contain one or more programs that guide the operations of computing node 500 in communication with various devices on corporate network 404. In this manner, computing node 500 may provide closed-loop feedback control of advanced supply chain management functions, as will be discussed in further detail below. The programs on HDD 506 may convert the elements and components of computing node 500 from a general purpose computer to a special purpose computer for providing automated supply chain management information and feedback, as will be discussed in further detail below. Computing node 500 may execute different programs depending on what type of operation is needed for a given situation, as will be also discussed in further detail below.

The term “storage mechanism” includes any type of memory, storage device or other mechanism for maintaining instructions or data in any format. “Computer-readable medium” is an extensible term including any memory, storage device, storage mechanism, and any other storage and signaling mechanisms including interfaces and devices such as network interface cards and buffers therein, as well as any communications devices and signals received and transmitted, and other current and evolving technologies that a computerized system can interpret, receive, and/or transmit. The term “memory” includes any random access memory (RAM), read only memory (ROM), flash memory, integrated circuits, and/or other memory components or elements. The term “storage device” includes any solid state storage media, disk drives, diskettes, networked services, tape drives, and other storage devices. Memories and storage devices may store computer-executable instructions to be executed by a processing element and/or control logic, and data which is manipulated by a processing element and/or control logic. The term “computer-readable storage medium” may refer to only tangible types of computer-readable media, which excludes intangible, transitory media, such as signals and carrier waves.

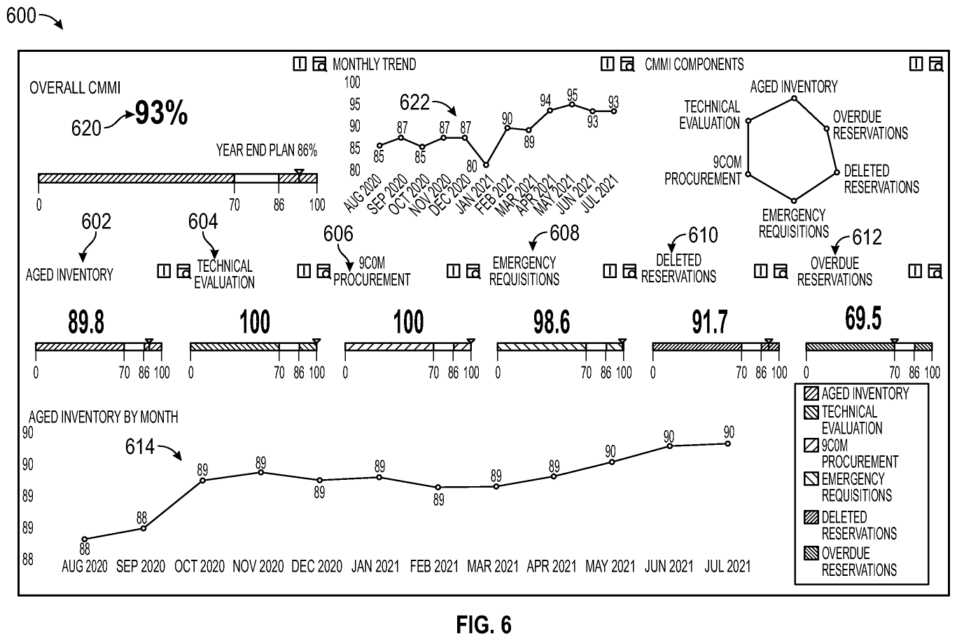

FIG. 6 depicts supply chain statistics 600 in accordance with one or more embodiments. Supply chain statistics 600 may be derived whole or in part from supply chain information 330 of FIG. 4, as will be discussed in further detail below. CMMIS 400 may derive supply chain statistics 600 in order to more efficiently guide behavior at plant 320, and in order to provide automated feedback for plant 320. Further, CMMIS 400 may derive supply chain statistics 600 for each of plants 320-380. For example, continuing with the numbering scheme of FIGS. 3 and 4, CMMIS 400 may request supply chain information 330 associated with plant 320, supply chain information 350 associated with plant 340, supply chain information 370 associated with plant 360, and supply chain information 390 associated with plant 380. CMMIS 400 may use all of this information to derive supply chain statistics 600 for each of plants 320-380, in order to improve efficiency and provide automated feedback for all of plants 320-380.

Using plant 320 as an example, supply chain statistics 600 may include a number of Key Performance Indicators (KPIs) 602-612 associated with plant 320. KPIs 602-612 may be referred to as: Aged Inventory 602, Technical Evaluation 604, 9COM Procurement 606, Emergency Requisitions 608, Deleted Reservations 610, and Overdue Reservations 612. Further, CMMIS 400 may use KPIs 602-612 as components to calculate an aggregate score associated with plant 320, which may be referred to as the Corporate Materials Management Index CMMI 620. Supply chain statistics 600 may include a graph 622 representing CMMI scores 620 for each of the last 12 months. The scores are a total score for each KPI out of 100. For example, the score for Aged Inventor is 89.8 out of 100. Additionally, supply chain statistics 600 may include a graph 614 representing KPI scores 602-612 for each of the last 12 months.

It will be appreciated that supply chain statistics 600 may provide an easy mechanism for employees of enterprise 300 to evaluate the supply chain performance of each of plants 320-380. In some embodiments, supply chain statistics 600 may only be available to executives of enterprise 300, which is the highest restriction level. In other embodiments, supply chain statistics 600 may be available to executives of enterprise 300, as well as to the employees of whichever plant 320-380 that the statistics are related to, but not to employees of whichever plants 320-380 that the statistics are not related to. This is the second highest restriction level. In other embodiments, supply chain statistics 600 for every plant 320-380 may be available to executives of enterprise 300, as well as to employees of every other plant 320-380, which is the lowest restriction level. It will be further appreciated that CMMIS 400 may derive a different set of statistics from supply chain information 330, other than supply chain statistics 600, without departing from the spirit and scope of the invention.

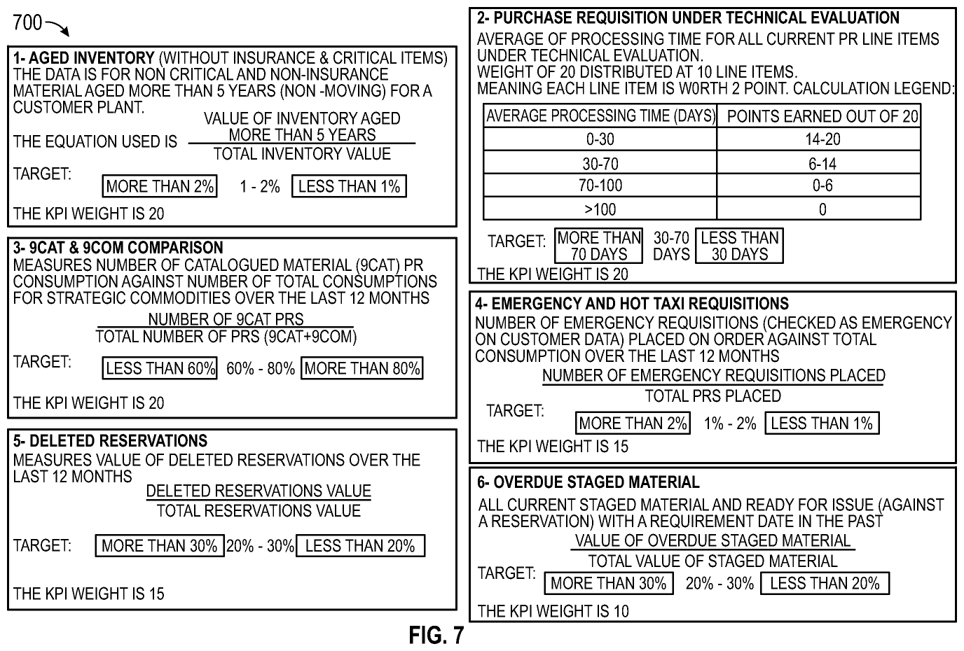

FIG. 7 demonstrates procedures 700 for calculating supply chain statistics 600 in accordance with one or more embodiments. CMMIS 400 may perform these calculations by requesting supply chain information 330 from plant 320, but this not intended to be limiting. For example, each plant 320-380 may calculate its own supply chain statistics 600 and send them to every other plant plant 320-380, or return them to CMMIS 400 for publishing. Each of KPIs 602-612 may be calculated differently, and they may be associated with their own unique set of alarms and performance levels. For the purposes of this example, the terms purchases, purchase requisitions, and procurements may be used interchangeably.

For example, Aged Inventory 602 may be calculated as the ratio of the value of all aged inventory over 5 years versus the total value of all inventories. The green or satisfactory level may be defined as less than 1%, the yellow or caution level may be defined as 1-2%, and the red or alarm level may be defined as more than 2%. Its component contribution towards CMMI 620 may be 20%. In one or more embodiments, CMMIS 400 may estimate Aged Inventory 602 using a linear regression machine learning model, which uses material consumptions history for the previous 5 years to predict current inventory age. In the example of FIG. 6, the Aged Inventory Score is 89.8 out of 100.

Technical Evaluation 604 may be calculated based on the average processing time for the most current 10 purchase items under technical evaluation. An average of 0-30 days earns 14-20 points, 30-70 days earns 6-14 points, 70-100 days earns 0-6 points, and greater than 100 days earns 0 points. The green or satisfactory level may be defined as less than 30 days, the yellow or caution level may be defined as 30-70 days, and the red or alarm level may be defined as more than 70 days. Its component contribution towards CMMI 620 for all line items may be 20%. In the example of FIG. 6, the Technical Evaluation 604 Score is 100 out of 100.

9COM Procurement 606 may be calculated as the ratio of all catalogued procurements versus the total number of all catalogued and commodity procurements over the last 12 months. Catalogued procurements refers to materials that are already described in the CMMIS 400 and can be ordered quickly. On the other hand, 9COM or commodity materials are not described in the system, so customers must provide full details of their requirements in order to order them. It may be advantageous to have a higher ratio of catalogued procurements vs commodity procurements. The green or satisfactory level may be defined as more than 80%, the yellow or caution level may be defined as 60-80%, and the red or alarm level may be defined as less than 60%. Its component contribution towards CMMI 620 may be 20%. In the example of FIG. 6, the 9COM Procurement 606 Score is 100 out of 100.

Emergency Requisitions 608 may be calculated as the ratio of the number of emergency requisitions placed versus the total number of all purchase requisitions over the last 12 months. The green or satisfactory level may be defined as less than 1%, the yellow or caution level may be defined as 1-2%, and the red or alarm level may be defined as more than 2%. Its component contribution towards CMMI 620 may be 15%. In the example of FIG. 6, the Emergency Requisitions 608 Score is 98.6 out of 100.

Deleted Reservations 610 may be calculated as the ratio of the value of deleted reservations versus the total value of all reservations over the last 12 months. The green or satisfactory level may be defined as less than 20%, the yellow or caution level may be defined as 20-30%, and the red or alarm level may be defined as more than 30%. Its component contribution towards CMMI 620 may be 15%. In the example of FIG. 6, the Deleted Reservations 610 Score is 91.7 out of 100.

Staged material refers to materials that are reserved for the customer in the system but the customer has not yet consumed them. Overdue staged material may refer to all current staged material ready for issue against a reservation with a requirement date in the past. In one or more embodiments, overdue staged material may refer to staged material with a requirement date exceeding two months in the past. Overdue Reservations 612 may be calculated as the ratio of the value of overdue staged material versus the total value of all staged material. The green or satisfactory level may be defined as less than 20%, the yellow or caution level may be defined as 20-30%, and the red or alarm level may be defined as more than 30%. Its component contribution towards CMMI 620 may be 10%. In the example of FIG. 6, the Overdue Reservations 612 Score is 69.5 out of 100.

In one or more embodiments, the total CMMI score is calculated by summing up the weighted performance score of the plurality of components. Here, for example, the total CMMI score of 93 is calculated as the following: (89.8*20%)+(100*20%)+(100*20%)+(98.6*15%)+(91.7*15%)+(69.5*10%)=˜93.

In some embodiments, CMMIS 400 may continually monitor supply chain statistics 600 and alarm levels for every plant 320-380. CMMI 620 may be calculated and recorded in the beginning of every month. Historical scores are maintained to monitor progress and highlight improvements. Further, when CMMIS 400 detects that an alarm level has been triggered, it may inform the offending plant 320-380 of the alarm and perform a remedial action, as will be discussed in further detail below.

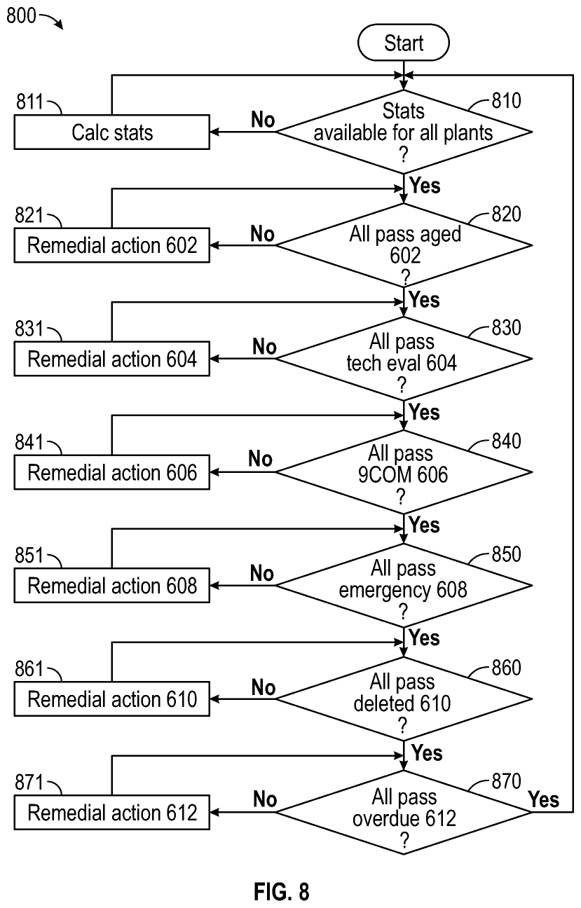

FIG. 8 depicts an automated Supply Chain Management (SCM) process 800 in accordance with one or more embodiments. Automated SCM process 800 may monitor supply chain statistics 600 at one or more of plants 320-380 in order to provide automated feedback and control based thereon. The automated SCM process 800 may be carried out by CMMIS 400 of enterprise 300 in communication with plants 320-380, in accordance with one or more embodiments. For example, one or more blocks of FIG. 8 may be performed by one or more components of CMMIS 400, as described in FIGS. 3 and 4 above, and/or by the computer system and processor of FIG. 5. While the various blocks in FIG. 8 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The process begins at step 810, which asks whether current supply chain statistics 600 are available for every plant 320-380 of enterprise 300. If the response is affirmative, then the process continues to step 820. If the response is negative, then the process continues to step 811, which causes CMMIS 400 to calculate current supply chain statistics 600 for every plant 320-380 whose statistics are out of date, according to the procedures described for FIG. 7 above. In one or more embodiments, CMMIS 400 may broadcast the calculated supply chain statistics 600 of every plant 320-380 to every other plant 320-380, which may cause the supply chain statistics 600 of every plant 320-380 to be viewable by plant managers at every plant 320-380. For example, the CMMIS 400 may broadcast the supply chain statistics 600 of every plant 320-380 to industrial server 325 of plant 320 for viewing by plant manager 328, industrial server 345 of plant 340 for viewing by plant manager 348, industrial server 365 of plant 360 for viewing by plant manager 368, and industrial server 385 of plant 380 for viewing by plant manager 388. Additionally, in broadcasting the calculated supply chain statistics 600 of every plant 320-380 to every other plant 320-380, CMMIS 400 may also broadcast a ranking of aggregated CMMI 620 scores for each of the plants. In this way, the plant managers for each plant may be able to view the supply chain performance of their own plant in relation to every other plant. In this way, the plant managers for each plant may be motivated improve their performance in order to increase their ranking. In an alternative embodiment, CMMIS 400 may only send calculated supply chain statistics 600 to plants 320-380 that are related to their own plant. In this embodiment, CMMIS 400 may rely on personnel at corporate office 460 for monitoring competition between plants 320-380.

Next, the process continues to step 820, which asks whether all plants pass the Aged Inventory 602 check. If the response is affirmative, then the process continues to step 830. If the response is negative, then the process continues to step 821, which may cause CMMIS 400 to trigger an alarm and perform one or more remedial actions associated with Aged Inventory 602 check. Remedial actions associated with Aged Inventory 602 check may include sending a workflow to the offending plant requesting that the plant manager validate its level of aged inventory and perform an immediately required appropriate action. For example, the workflow may be sent to plant manager 328 on industrial server 325 at plant 320. It will be appreciated that the workflow may be sent to the offending plant manager, industrial server, and plant that triggered the alarm. The immediately required appropriate action may include choosing one of: (1) keeping the aged items for an additional 6 months; (2) writing the aged items off immediately; or (3) freeing the stock for use by other plants. If the plant manager chooses (1), then process 800 may check again after 6 months to see of the aged items have been consumed, and may immediately issue a write-off order if they have not. If the plant manager chooses (2), then the aged items may be automatically moved by a robot to a hold location at the warehouse, where they will ultimately be transferred to auction and disposed of. If the plant manager chooses (3), then the process may determine if there are any matching open reservation for the items at another plant, which may cause the other plant with a matching reservation to automatically purchase and take possession of the aged items. The immediately required appropriate action may be executed by plant manager 328 on industrial server 325 at plant 320. It will be appreciated that the immediately required appropriate action may be executed by the offending plant manager, industrial server, and plant that triggered the alarm. Additionally, the process may prevent plants from purchasing new items until the aged items are consumed. All of actions 1-3 may cause the offending plant manager's CMNII 620 score to be recalculated automatically. Afterwards, the process returns to step 820. The process may continue this way between step 820 and step 821 until all plants have passed the Aged Inventory 602 check or have been issued a remedial action.

At step 830 the process asks whether all plants pass the Technical Evaluation 604 check, which may be evaluated according to the parameters described for FIG. 7 above. If the response is affirmative, then the process continues to step 840. If the response is negative, then the process continues to step 831, which causes CMMIS 400 to trigger an alarm and perform one or more remedial actions associated with Technical Evaluation 604 check. Remedial actions associated with Technical Evaluation 604 check may include sending a workflow to the offending plant requesting that the plant manager complete any non-compliant technical evaluations within the next 3-5 days. For example, the workflow may be sent to plant manager 328 on industrial server 325 at plant 320. It will be appreciated that the workflow may be sent to the offending plant manager, industrial server, and plant that triggered the alarm. Afterwards, the process returns to step 830. The process may continue this way between step 830 and step 831 until all plants have passed the Aged Inventory 602 check or have been issued a remedial action.

At step 840 the process asks asks whether all plants pass the 9COM Procurement 606 check, which may be evaluated according to the parameters described for FIG. 7 above. If the response is affirmative, then the process continues to step 850. If the response is negative, then the process continues to step 841, which causes CMMIS 400 to perform one or more remedial actions associated with 9COM Procurement 606 check. Remedial actions associated with 9COM Procurement 606 check may include sending a workflow to the offending plant requesting that the plant manager reduce the creation of commodity 9COM materials and increase the creation of catalogued 9CAT materials. For example, the workflow may be sent to plant manager 328 on industrial server 325 at plant 320. It will be appreciated that the workflow may be sent to the offending plant manager, industrial server, and plant that triggered the alarm. Afterwards, the process returns to step 840. The process may continue this way between step 840 and step 841 until all plants have passed the Aged Inventory 602 check or have been issued a remedial action.

At step 850 the process asks whether all plants pass the Emergency Requisitions 608 check, which may be evaluated according to the parameters described for FIG. 7 above. If the response is affirmative, then the process continues to step 860. If the response is negative, then the process continues to step 851, which causes CMMIS 400 to trigger an alarm and perform one or more remedial actions associated with Emergency Requisitions 608 check. Remedial actions associated with Emergency Requisitions 608 check may include sending a workflow to the offending plant requesting that the plant manager not request any additional emergency requisition. Process 800 may also request that the offending plant manager attest to the validity of any outstanding emergency requisitions. For example, the workflow or request may be sent to plant manager 328 on industrial server 325 at plant 320. It will be appreciated that the request or workflow may be sent to the offending plant manager, industrial server, and plant that triggered the alarm. Finally, process 800 may flag any emergency requisitions that the offending plant manager created and did not consume. Afterwards, the process returns to step 850. The process may continue this way between step 850 and step 851 until all plants have passed the Aged Inventory 602 check or have been issued a remedial action.

At step 860 the process asks whether all plants pass the Deleted Reservations 610 check, which may be evaluated according to the parameters described for FIG. 7 above. If the response is affirmative, then the process continues to step 870. If the response is negative, then the process continues to step 861, which causes CMMIS 400 to trigger an alarm and perform one or more remedial actions associated with Deleted Reservations 610 check. Remedial actions associated with Deleted Reservations 610 check may include sending a workflow to the offending plant requesting that the plant manager impose more restrictions at the offending plant and gain better control of their budget. Process 800 may also remind the offending plant manager than any reservations received and not consumed may negatively affect Aged Inventory 602. For example, the workflow or reminder may be sent to plant manager 328 on industrial server 325 at plant 320. It will be appreciated that the workflow may be sent to the offending plant manager, industrial server, and plant that triggered the alarm. Afterwards, the process returns to step 860. The process may continue this way between step 860 and step 861 until all plants have passed the Aged Inventory 602 check or have been issued a remedial action.

At step 870 the process asks whether all plants pass the Overdue Reservations 612 check, which may be evaluated according to the parameters described for FIG. 7 above. If the response is affirmative, then the process starts over at step 810. If the response is negative, then the process continues to step 871, which causes CMMIS 400 to trigger an alarm and perform one or more remedial actions associated with Overdue Reservations 612 check. Remedial actions associated with Overdue Reservations 612 check may include sending a workflow to the offending plant requesting that the plant manager impose more restrictions at the offending plant and gain better control of their budget. For example, the workflow may be sent to plant manager 328 on industrial server 325 at plant 320. It will be appreciated that the workflow may be sent to the offending plant manager, industrial server, and plant that triggered the alarm. Afterwards, the process returns to step 870. The process may continue this way between step 870 and step 871 until all plants have passed the Aged Inventory 602 check or have been issued a remedial action, at which point the process starts over at step 810.

Process 800 may continue checking plants 320-380 for current supply chain statistics 600 and alarm limits indefinitely or until requested to stop. Further, process 800 may continue through all of steps 810-870, including any necessary remedial actions, automatically without any human intervention.

Embodiments disclosed herein provide a method and apparatus for automatically detecting and updating supply chain usage statistics, in addition to automatically sending alarms when usage gets out of control. A system is also provided for generating automated data collection tools, calculations, and active feedback in order to improve the supply chain purchasing behavior of plant managers. The technology provides plant managers full view of any number of facilities (e.g., more than 40 active plants), and allows them to quickly see who is green, red, or yellow, in order to generate warnings, highlight areas of improvement, and realize benefits for each customer plant. Additionally, since current statistics may be available to all plants, all plant managers will be driven to be the best, and it will be obvious who is performing the best. This inventory optimization method helps to lower inventory, reduce requests for unneeded materials, and will help improve the usage of space at warehouses.

The new CMMI capabilities disclosed herein reduce technical cycle time and improved over aged inventory, and emergency requisitions. The design optimizes inventory and can result in reduction of millions in costs and expanded befits to customers. A single platform as described herein allows users to trace inventory through all viewing key supply chain KPIs. This solves inventory increase problems in supply chains. The platform enables all users to view and monitor the data. The digitized platform includes showing inventory data and their detail purchase orders, reservation nos., materials, etc. across all company plants.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for providing automated supply chain management at one or more locations, the method comprising:
monitoring the one or more locations in order to calculate one or more supply chain metrics;
determining whether at least one of the supply chain metrics has exceeded an alarm level;
in response to determining that at least one of the supply chain metrics has exceeded the alarm level, automatically performing a remedial action at a location that was responsible for the alarm;
wherein the one or more supply chain metrics are related to one or more of: emergency purchases, canceled purchases, and aged inventory; and
wherein each of the one or more supply chain metrics is assigned an individual weighted supply chain metric score out of 100.

2. The method of claim 1, wherein monitoring the one or more locations, calculating the one or more metrics, and automatically performing the remedial action are performed by a computer without any human intervention.

3. The method of claim 2, wherein aged inventory further comprises an aged inventory metric, and calculating the aged inventory metric comprises applying a linear regression machine learning model that uses historical inventory consumption data.

4. The method of claim 2, wherein the performing the remedial action comprises offering the aged inventory to another of the one or more locations that was not responsible for the alarm, and wherein the another of the one or more locations automatically purchases and takes possession of the aged inventory based on having a matching open order for the aged inventory.

5. The method of claim 1, further comprising: in response to performing the remedial action, automatically recalculating the one or more supply chain metrics associated with the location that was responsible for the alarm.

6. The method of claim 5, wherein the one or more supply chain metrics comprise two or more supply chain metrics as well as an aggregate metric.

7. The method of claim 6, wherein the aggregate metric is calculated by summing the individual weighted supply chain metrics scores for each of the two or more supply chain metrics.

8. A non-transitory computer-readable storage medium having computer-readable instructions stored thereon, which when executed by a computer cause the computer to perform the method comprising:
monitoring one or more locations in order to calculate one or more supply chain metrics;
determining whether at least one of the supply chain metrics has exceeded an alarm level;
in response to determining that at least one of the supply chain metrics has exceeded the alarm level, automatically performing a remedial action at a location that was responsible for the alarm;
wherein the one or more supply chain metrics are related to one or more of: emergency purchases, canceled purchases, and aged inventory; and
wherein each of the one or more supply chain metrics is assigned an individual weighted supply chain metric score out of 100.

9. The non-transitory computer-readable storage medium of claim 8, wherein monitoring the one or more locations, calculating the one or more metrics, and automatically performing the remedial action are performed by the computer without any human intervention.

10. The non-transitory computer-readable storage medium of claim 9, wherein aged inventory further comprises an aged inventory metric, and calculating the aged inventory metric comprises applying a linear regression machine learning model that uses historical inventory consumption data.

11. The non-transitory computer-readable storage medium of claim 10, wherein the performing the remedial action comprises offering the aged inventory to another of the one or more locations that was not responsible for the alarm, and wherein the another of the one or more locations automatically purchases and takes possession of the aged inventory based on having a matching open order for the aged inventory.

12. The non-transitory computer-readable storage medium of claim 8, further comprising: in response to performing the remedial action, automatically recalculating the one or more supply chain metrics associated with the location that was responsible for the alarm.

13. The non-transitory computer-readable storage medium of claim 12, wherein the one or more supply chain metrics comprise two or more supply chain metrics as well as an aggregate metric.

14. The non-transitory computer-readable storage medium of claim 11, wherein the aggregate metric is calculated by summing the individual weighted supply chain metrics scores for each of the two or more supply chain metrics.

15. A system comprising:
one or more manufacturing locations; and
an automated supply chain management computer, wherein the automated supply chain management computer is configured to:
monitor the one or more locations in order to calculate one or more supply chain metrics;
determine whether at least one of the supply chain metrics has exceeded an alarm level; and
in response to determining that at least one of the supply chain metrics has exceeded the alarm level, automatically performing a remedial action at a location that was responsible for the alarm;
wherein the one or more supply chain metrics are related to one or more of: emergency purchases, canceled purchases, and aged inventory; and
wherein each of the one or more supply chain metrics is assigned an individual weighted supply chain metric score out of 100.

16. The system of claim 15, wherein monitoring the one or more locations, calculating the one or more metrics, and automatically performing the remedial action are performed by a computer without any human intervention.

17. The system of claim 16, wherein aged inventory further comprises an aged inventory metric, and calculating the aged inventory metric comprises applying a linear regression machine learning model that uses historical inventory consumption data.

18. The system of claim 17, wherein the performing the remedial action comprises offering the aged inventory to another of the one or more locations that was not responsible for the alarm, and wherein the another of the one or more locations automatically purchases and takes possession of the aged inventory based on having a matching open order for the aged inventory.

19. The system of claim 15, further comprising: in response to performing the remedial action, automatically recalculating the one or more supply chain metrics associated with the location that was responsible for the alarm.

20. The system of claim 15, wherein the one or more supply chain metrics comprise two or more supply chain metrics as well as an aggregate metric, wherein the aggregate metric is calculated by summing the individual weighted supply chain metrics scores for each of the two or more supply chain metrics.
